(19) United States
(12) Patent Application Publication
(10) Pub. No.: US 2010/0270815 A1
(43) Pub. Date: Oct. 28, 2010

(54) OPENING AND CLOSING MEMBER CONTROL DEVICE

(75) Inventors: Yasutaka SHINODA, Anjo-shi (JP); Akira Tani, Anjo-shi (JP); Toshio Machida, Toyota-shi (JP); Yasuhiro Nagaya, Anjo-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/729,893

(22) Filed: Mar. 23, 2010

(30) Foreign Application Priority Data
Apr. 28, 2009 (JP) 2009-109463

(51) Int. Cl. E05C 3/06

(52) U.S. Cl. 292/201

(57) ABSTRACT

An opening and closing member control device includes: a latch that pulls in or releases a striker; a displacement member that operates the latch through a latch operation mechanism and is displaced within a movement area including a close area, a release area, and a neutral area positioned between the close and release areas; a motor that displaces the displacement member; a rotation counter that counts a rotation amount of the motor; and a control unit that controls, based on the rotation amount of the motor, rotation of the motor to perform a first returning operation for returning the displacement member to a neutral position set in the neutral area from the close area after a close operation of the displacement member, and a second returning operation for returning the displacement member to the neutral position from the release area after a release operation of the displacement member.

### CROSS REFERENCE TO RELATED APPLICATION

The present application claims priority from Japanese Patent Application No. 2009-109463, which was filed on Apr. 28, 2009, the disclosure of which is incorporated herein by reference in its entirety.

### TECHNICAL FIELD

This disclosure relates to an opening and closing member control device capable of performing a close operation for establishing an engagement state of a latch and a striker, and a release operation for releasing the engagement state of the latch and the striker, according to a rotational displacement based on an operation of a motor.

### BACKGROUND DISCUSSION

In general, there is known a door lock operation device for a vehicles, which performs a locking operation by rotating an output shaft of an actuator in a normal direction, and an unlocking operation by rotating it in a reverse direction (for example, JP-2002-81249A). In addition, there is known a door closer device for a vehicle, which performs a close operation for rotating a latch and pulling in a striker by displacing a driven gear in a direction as a displacement member that is applied with power of a motor that enables normal and reverse rotations, and a release operation for rotating a pole to release an engagement of a latch and the pole by displacing the driven gear in another direction (for example, JP-2007-2589A).

### SUMMARY

Such a type of device has a release function of releasing an engagement of a latch and a striker by displacing a displacement member that receives motor power, such as, a sector gear in a release direction with respect to a neutral area, and a close function of making the latch pull in the striker by driving the displacement member in a close direction with respect to the neutral area. Here, in a case where the displacement member is displaced to the neutral area by the motor power after performing the release function and the close function, a neutrality detection unit such as a switch is needed to control stopping of the motor.

The switch as the neutrality detection unit has a dispersion in detection characteristics for each individual. When the switch having this dispersion in detection characteristics is used for the device, in order to absorb the dispersion (in order to reliably detect the neutral area), there is a need to set a wide neutral area. That is, there is a need to set a wide neutral area in consideration of the maximum dispersion. For this, a size of the sector gear has to be increased, and this results in increases in the sizes of peripheral devices (a case member (housing), a motor, and the like) that follow the control of the sector gear. As a result, the weight and size of the entire apparatus as well as material costs are increased.

Thus, a need exists for an opening and closing member control device which is not susceptible to the drawback mentioned above.

In order to solve the problems, an object of this disclosure is to provide an opening and closing member which achieves a decrease in size.

In order to achieve the object, an aspect of this disclosure provides an opening and closing member control device comprising:

a latch that pulls in or releases a striker;

a displacement member that operates the latch through a latch operation mechanism and is displaced within a movement area including a close area for allowing the latch to be in a pulling state, a release area for allowing the latch to be in a releasing state, and a neutral area positioned between the close and release areas;

a motor that displaces the displacement member;

a rotation counter that counts a rotation amount of the motor; and

a control unit that controls, based on the rotation amount of the motor, rotation of the motor to perform a first returning operation for returning the displacement member to a neutral position set in the neutral area from the close area after a close operation of the displacement member, and a second returning operation for returning the displacement member to the neutral position from the release area after a release operation of the displacement member.

Another aspect of this disclosure provides an opening and closing member control device comprising:

a latch that pulls in or releases a striker;

a displacement member that operates the latch through a latch operation mechanism and is displaced within a movement area including a close area for allowing the latch to be in a pulling state, a release area for allowing the latch to be in a releasing state, and a neutral area positioned between the close and release areas;

a latch state evaluator that evaluates a state of the latch;

a motor that displaces the displacement member;

a control unit that determines a value of a supply voltage supplied to the motor based on the state of the latch; and

a voltage generator that generates the supply voltage at the determined value using PWM control.

### BRIEF DESCRIPTION OF THE DRAWINGS

FIG. 1 is a diagram illustrating a side of a vehicle including an opening and closing member control device.

FIG. 2 is an enlarged view schematically illustrating a striker and a door lock device.

FIGS. 3A to 3D are diagrams illustrating operations of the door lock device during closing of a door.

FIGS. 4A to 4D are diagrams illustrating operations of the door lock device during opening of the door.

FIG. 5 is a diagram illustrating transitions of outputs of switches.

FIG. 6 is a block diagram schematically illustrating a configuration of a control unit.

FIG. 7 is a diagram schematically illustrating a movement area of a sector gear.

FIGS. 8A and 8B are diagrams illustrating a rotational area of the sector gear.

FIG. 9 is a diagram schematically illustrating a returning operation of the sector gear during the opening of the door.

FIG. 10 is a diagram schematically illustrating the returning operation of the sector gear during the closing of the door.

FIG. 11 is a diagram schematically illustrating a voltage generator.

FIG. 12 is a diagram illustrating an example of a PWM control signal output from the control unit.

FIG. 13 is a diagram illustrating an example of a value of a supply voltage determined based on a state of a latch.

FIG. 14 is a flowchart of processes during the closing of the door.

FIG. 15 is a flowchart of processes during the opening of the door.

### DETAILED DESCRIPTION

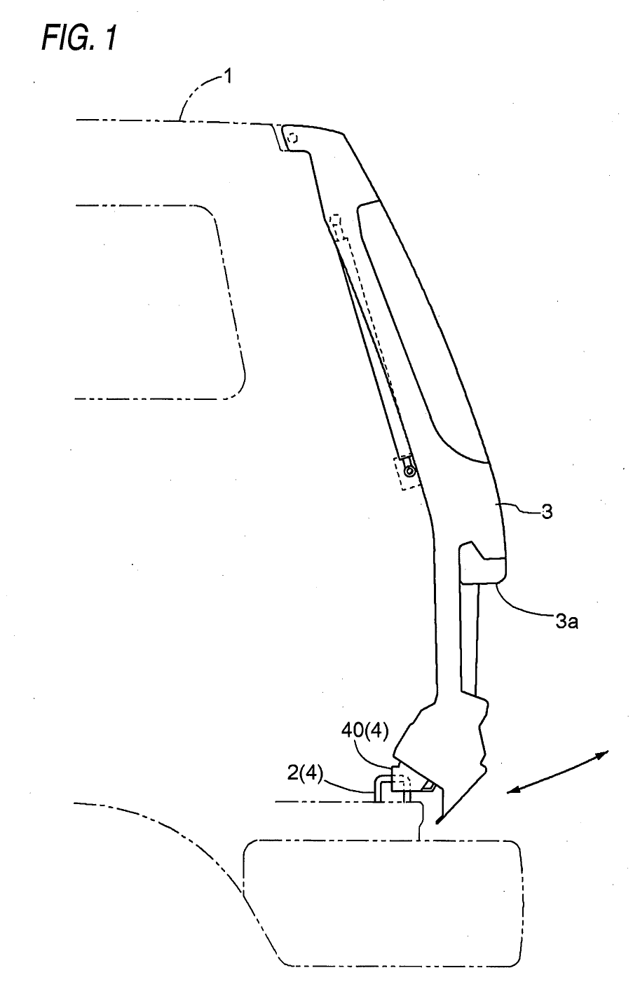

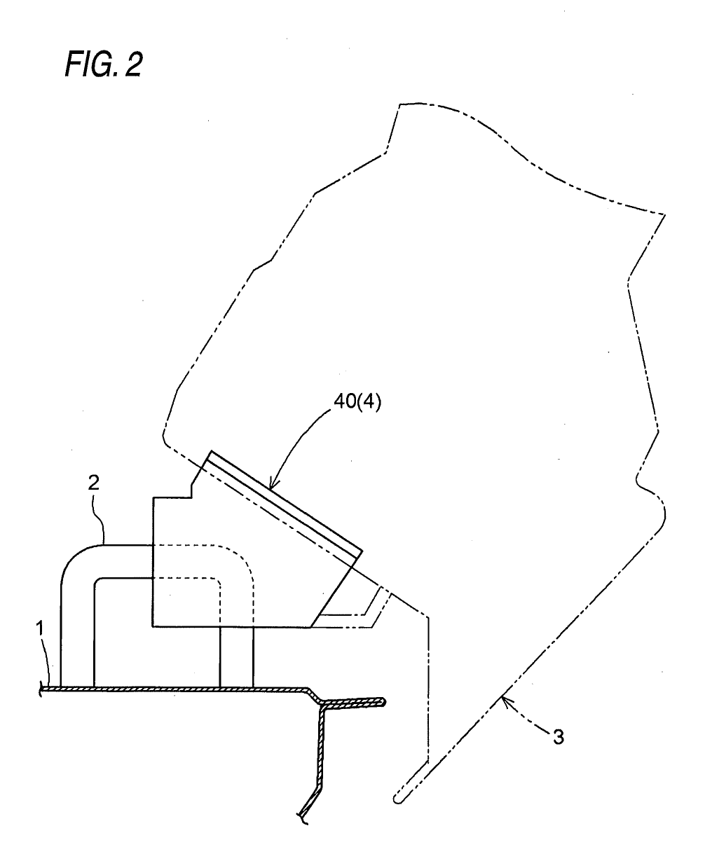

Hereinafter, an opening and closing member control device 100 according to the embodiment will be described. The opening and closing member control device 100 is used as a device having a function of automatically opening and closing an opening and closing member. In this embodiment, as an application example suitable for the opening and closing control device 100, a device for opening and closing a back door (luggage door) 3 of a vehicle is exemplified. Therefore, in this embodiment, the opening and closing member corresponds to the back door 3 of the vehicle. FIG. 1 is a diagram illustrating a side of a vehicle including the opening and closing member control device 100. FIG. 2 is an enlarged view schematically illustrating a striker 2 and a door opening and closing operation mechanism 40 of the opening and closing member control device 100.

In FIGS. 1 and 2, a door lock device 4 installed between a vehicle body 1 having the opening and closing member control device 100 and the back door 3 is illustrated. In this embodiment, the door lock device 4 includes the door opening and closing operation mechanism 40 provided on a side of the back door 3 and the striker 2 provided on a side of the vehicle body 1. The striker 2 is disposed at an opening portion of the vehicle body 1, which is shown during opening and closing of the back door 3, so as to be engaged with the door opening and closing operation mechanism 40. Of course, the striker 2 may be installed in a portion other than that illustrated in FIG. 1. In addition, an open handle 3a is provided on an outer side of the back door 3.

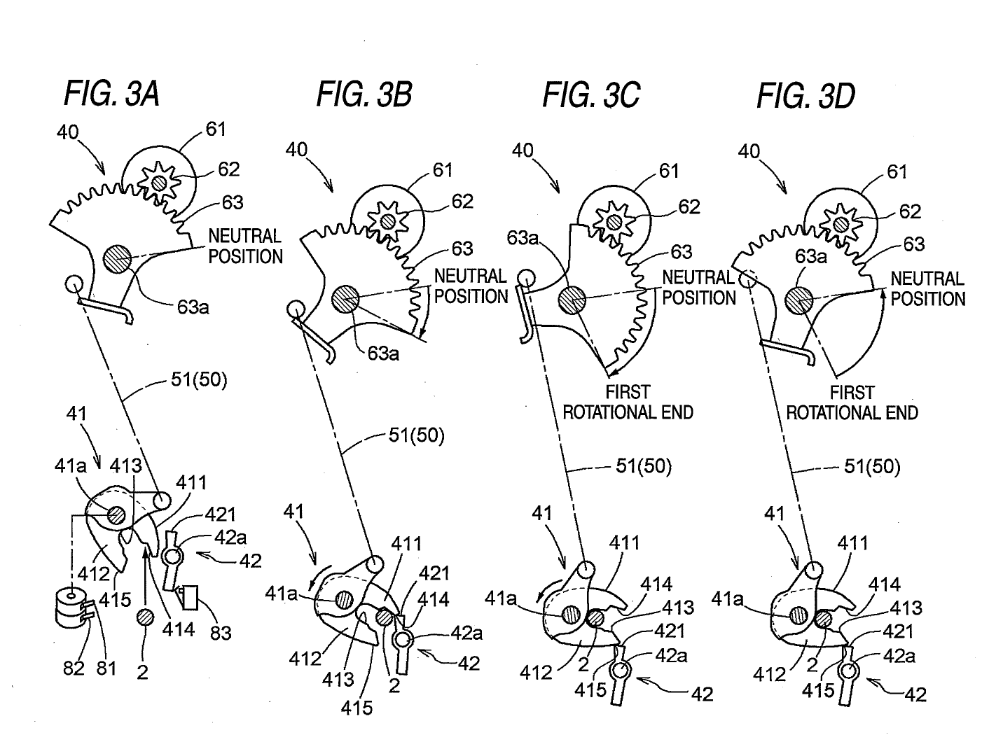

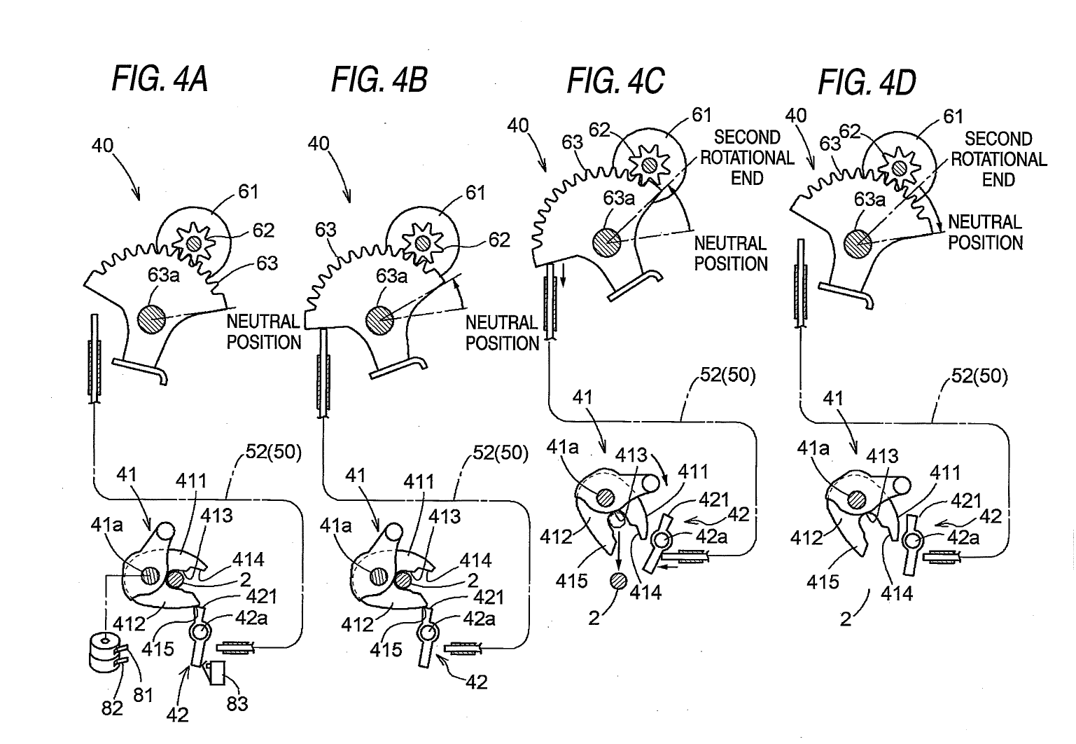

Although detailed description will be provided later, the door opening and closing operation mechanism 40 is operated during any of the opening and closing of the back door 3. FIGS. 3A to 3D are diagrams illustrating operations of the door lock device 4 during the closing of the back door 3. FIGS. 4A and 4D are diagrams illustrating operations of the door lock device 4 during opening of the back door 4. The door lock device 4 includes a latch 41 for pulling in or releasing the striker 2, a pole 42 for restricting rotation of the latch 41 in a ratchet-type manner, and a latch operation mechanism 50 for operating the latch 41 or the pole 42. The latch 41 is configured as a panel-shaped member to perform the operation of pulling in the striker 2 toward a main part of the back door 3.

In order to apply an operational displacement to the latch operation mechanism 50, the door opening and closing operation mechanism 40 includes a closer motor 61, and as a pair of transmission gears for transmitting rotation of the closer motor 61, a pinion gear 62 and a sector gear 63 for operating the latch 41 through the latch operation mechanism 50. The sector gear 63 is supported to rotate about a rotation shaft 63a provided in a housing (not shown).

In addition, although detailed description will be provided later, the sector gear 63 is displaced within a movement area including a close area for allowing the latch 41 to be in a pulling state, a release area for allowing the latch 41 to be in a releasing state, and a neutral area positioned between the close area and the release area. The movement of the sector gear 63 is implemented by rotational power output from the closer motor 61.

The latch 41 is supported to rotate about a support shaft 41a provided in the housing (not shown) so as to be biased in a return posture as illustrated in FIG. 3A by a spring or the like (not shown). The latch 41 includes a first arm portion 411, a second arm portion 412, and a locking groove portion 413 for receiving the striker 2 therebetween. The first arm portion 411 is provided with a half engagement surface 414 that is engaged with an abutting operation portion 421 of the pole 42 at a half latch position. The second arm portion 412 is provided with a full engagement surface 415 that is engaged with the abutting operation portion 421 of the pole 42 at a full latch position.

The pole 42 is supported to rotate about a support shaft core 42a between an engagement posture and a disengagement posture. The abutting operation portion 421 of the pole 42 is configured to be positioned in rotation trajectories of the first and second arm portions 411 and 412 at the engagement and disengagement postures. The pole 42 is biased to return to the engagement posture by a spring or the like (not shown). The engagement posture is a posture before the engagement with the latch 41 and corresponds to the posture illustrated in FIG. 3A.

As a position detector for detecting a rotational position of the latch 41, a first latch switch 81 and a second latch switch 82 in a rotary switch type are provided for a tube which is to be detected and is rotated about a support shaft 41a integrally with the latch 41. The first patch switch 81 is used for detecting the latch 41 being in a half latch area. The second latch switch 82 is used for detecting the latch 41 being in a full latch area.

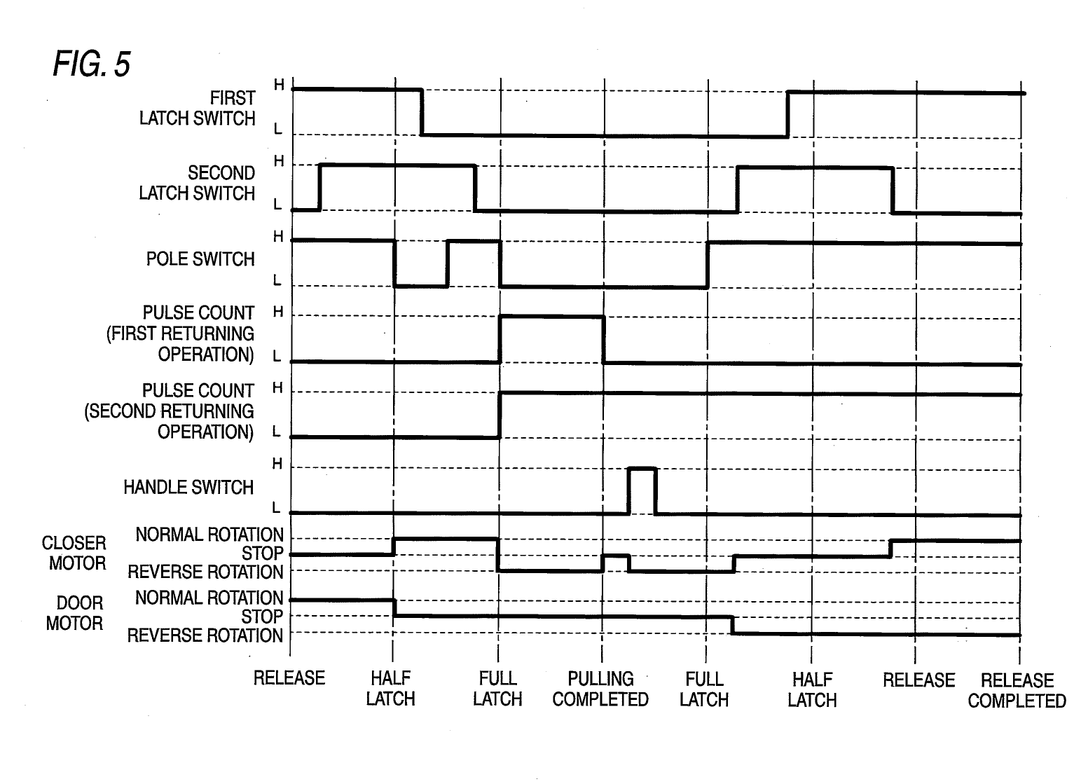

In addition, in this embodiment, as illustrated in FIG. 5, the first latch switch 81 is set to transit from the High (On) level to the Low (Off) level in a case where the latch 41 exceeds the half latch area from the release state. In addition, the first latch switch 81 is set to transit from the Low (Off) level to the High (On) level when the latch 41 reaches the half latch area from the pulling-in state.

The second latch switch 82 is, as illustrated in FIG. 5, set to transit from the Low (Off) level to the High (On) level when the latch 41 reaches the half latch area from the release state and transit from the High (On) level to the Low (Off) level when the latch 41 reaches the full latch area. In addition, the second latch switch 82 is set to transit from the Low (Off) level to the High (On) level when the latch 41 exceeds the full latch area from the pulling-in state and transit from the High (On) level to the Low (Off) level when the latch 41 exceeds the half latch area.

Returning to FIGS. 3A to 3D, as a position detector for detecting a rotational position of the pole 42, a pole switch 83 in a stroke switch type is provided. The pole switch 83 detects the pole 42 being in the posture engaged with the latch 41. In this embodiment, as illustrated in FIG. 5, the pole switch 83 is in the High (On) level when the pole 42 is in an area before and including the half latch position where the pole 42 is engaged with the first arm portion 411 of the latch 41. In addition, the pole switch 83 is in the High (On) level when the pole 42 is in an area before and including the full latch position where the pole 42 is engaged with the second arm portion 412 of the latch 41. That is, during the close operation of the back door 3, a point at which the level of the pole switch 83 falls first corresponds to the halt latch position, and a point at which the level of the pole switch 83 falls second corresponds to the full latch position.

The latch operation mechanism 50 includes a close operation mechanism 51 (see FIGS. 3A to 3D) and a release operation mechanism 52 (see FIGS. 4A to 4D). The close operation mechanism 51 receives a rotational displacement of the sector gear 63 as an input and outputs a rotational operation for the latch 41. The release operation mechanism 52 receives the rotational displacement of the sector gear 63 as an input and outputs a rotational operation (disengagement operation) for the pole 42. The close area which is the rotational area of the sector gear 63 for operating the close operation mechanism 51 and the release area of the sector gear 63 for operating the release operation mechanism 52 are different from each other with the neutral area interposed therebetween (detailed description will be provided later). Therefore, the close operation mechanism 51 and the release operation mechanism 52 are individually operated.

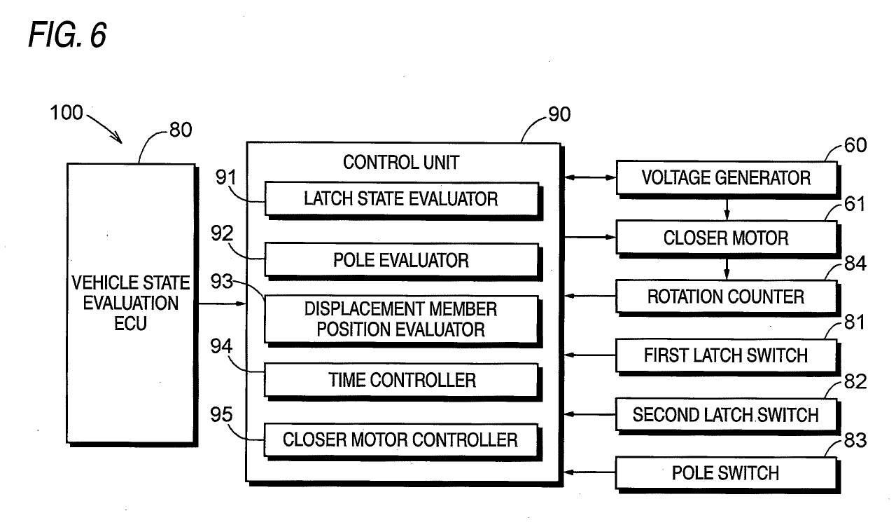

FIG. 6 is a block diagram schematically illustrating a configuration of a control unit 90 for controlling the door opening and closing operation mechanism 40. A voltage generator 60, the first latch switch 81, the second latch switch 82, the pole switch 83, and a rotation counter 84 are connected to an input port of the control unit 90. In addition, the voltage generator 60 and the closer motor 61 are connected to an output port of the control unit 90 through a driver (not shown). Moreover, the control unit 90 is connected to a vehicle state evaluation ECU 80 for evaluating a state of the vehicle and outputting information on the vehicle state to acquire the information on the vehicle state related to the opening and the closing of the back door 3.

The control unit 90 includes a latch state evaluator 91, a pole evaluator 92, a displacement member position evaluator 93, a timer controller 94, and a closer motor controller 95. In addition, in order for the control unit 90 to perform various processes for opening and closing the back door 3 using a CPU as a core member, the function units are configured by hardware, software, or both.

The latch state evaluator 91 evaluates a state of the latch 41 on the basis of a signal from the first or second latch switch 81 or 82. The pole evaluator 92 evaluates a state of the pole 42 on the basis of a signal from the pole switch 83. The displacement member position evaluator 93 evaluates the rotational position of the sector gear 63 on the basis of an output signal from the rotation counter 84 which will be described later. The timer controller 94 allows timer control using an internal timer or the like. The closer motor controller 95 generates and outputs a control signal to the closer motor 61 on the basis of the evaluation results of the latch state evaluator 91, the pole evaluator 92, and the displacement member position evaluator 93 as well as the timer information of the timer controller 94.

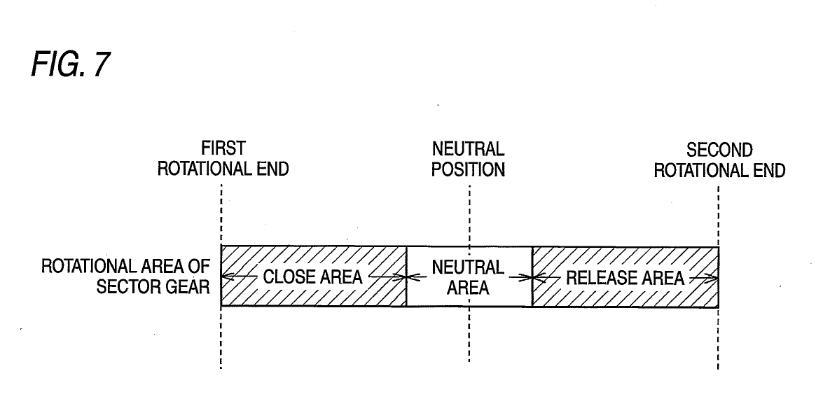

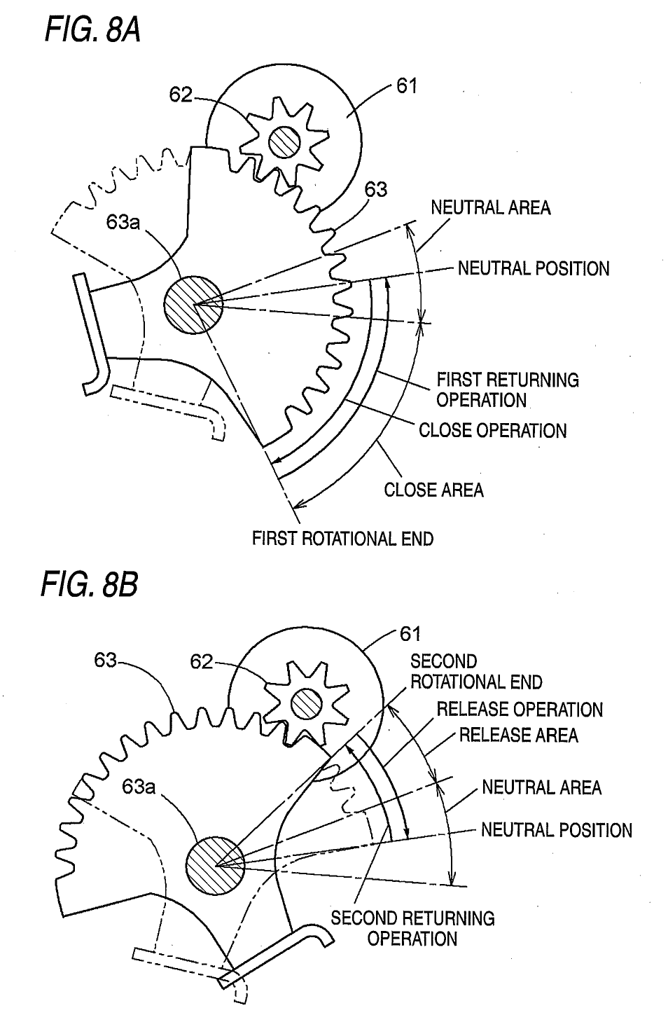

The close operation for pulling the striker 2 in the latch 41 is performed by operating the close operation mechanism 51 through the sector gear 63. In addition, the release operation for releasing the striker 2 from the latch 41 is performed by operating the release operation mechanism 52 through the sector gear 63. The rotational area of the sector gear 63 that guides the close operation and the release operation are classified into the close area, the release area, and the neutral area interposed therebetween as illustrated in FIGS. 7, 8A and 8B. A center portion of the neutral area is set to a neutral position. In addition, as illustrated in FIGS. 7, 8A and 8B, the center portion of the neutral area is suitable for the neutral position; however, the neutral position may not be set to the center portion. The neutral position may be set to a predetermined position in the neutral area in advance.

The close operation is guided by rotating (rotating clockwise in FIGS. 8A and 8B) the sector gear 63 toward a first rotational end which is a rotational end on a close area side in the close area (see FIG. 8A). After the close operation of the sector gear 63 (after terminating the close operation), a first returning operation (neutrality returning operation) for returning the sector gear 63 to the neutral area from the close area is performed. During the first returning operation, the sector gear 63 is rotated in the reverse direction (rotated counterclockwise in FIGS. 8A and 8B) to pass the close area and then enter the neutral area, and is stopped at the neutral position.

The release operation is guided by rotating (rotating counterclockwise in FIGS. 8A and 8B) the sector gear 63 toward a second rotational end in the release area (see FIG. 8B). After the release operation of the sector gear 63 (after terminating the release operation), a second returning operation (neutrality returning operation) for returning the sector gear 63 to the neutral area from the release area is performed. During the second returning operation, the sector gear 63 is rotated in the reverse direction (rotated clockwise in FIGS. 8A and 8B) to pass the release area and then enter the neutral area, and is stopped at the neutral position. As described above, the sector gear 63 is controlled so that the stop position of the sector gear 63 after the first returning operation and the stop position of the sector gear 63 after the second returning operation are the same position (that is, the neutral position).

The rotation counter 84 counts an amount of rotation of the closer motor 61 for displacing the sector gear 63. The amount of rotation of the closer motor 61 is an amount representing the number of rotations of the closer motor 61. As described above, for rotation amount detection, for example, a Hall element may be used. The Hall element is an element for detecting a magnetic flux using the Hall effect that is the production of a voltage difference in response to a force exerted on charges in a conductor to move them in a transverse direction when a magnetic field is applied to the conductor through which current flows.

When the Hall element is used, a permanent magnet may be provided in the vicinity of a rotation shaft of the closer motor 61 to allow the Hall element to detect a magnetic field that changes with the rotation of the closer motor 61. Since a detection result output from the Hall element is an electrical pulse signal, the rotation counter 84 can detect the rotation amount of the closer motor 61 by counting the pulse signal. The number of pulses counted by the rotation counter 84 is transmitted to the control unit 90 as the rotation amount of the closer motor 61.

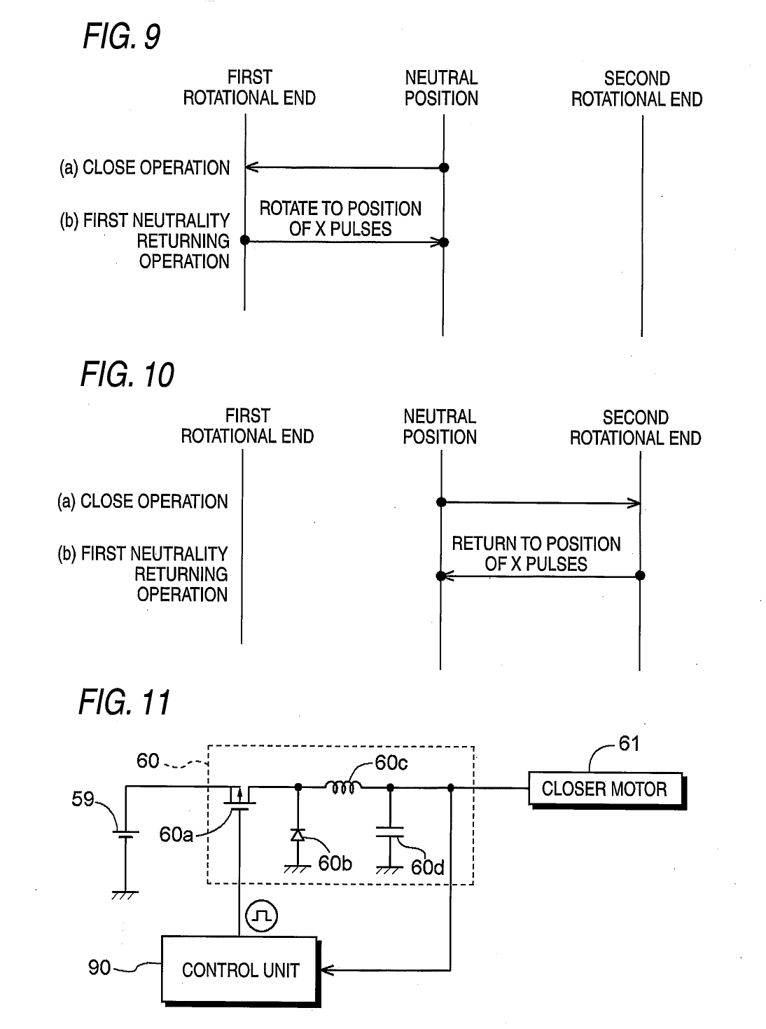

In this embodiment, during the first returning operation for returning the sector gear 63 to the neutral position from the close area after the close operation of the sector gear 63 and the second returning operation for returning the sector gear 63 to the neutral position after the release operation of the sector gear 63, the control unit 90 controls the rotation of the closer motor 61 on the basis of the rotation amount of the closer motor 61. In this embodiment, a rotation amount of the closer motor 61 needed for displacing the sector gear 63 from the first rotational end to the neutral position is calculated in advance and the control unit 90 (the closer motor controller 95) stores the calculation results. That is, the number of pulses (for example, X pulses) of a pulse signal output by displacing the sector gear 63 from the first rotational end to the neutral position with respect to the first rotational end is stored in advance. Accordingly, in order for the sector gear 63 positioned at the first rotational end to perform the first returning operation, as illustrated in FIG. 9, the closer motor controller 95 rotates (for example, drives in the reverse direction) the closer motor 61 until the rotation counter 84 counts X pulses of the pulse signal.

In order for the sector gear 63 positioned at the second rotational end to perform the second returning operation, as illustrated in FIG. 10, the closer motor controller 95 rotates the closer motor 61 by the stored number of pulses as illustrated in FIG. 10. That is, during the second returning operation for the rotation from the second rotational end, the closer motor controller 95 subtracts the pulse signals detected in response to the rotation of the closer motor 61 from the current number of pulses counted by the rotation counter 84 and rotates the closer motor 61 (for example, rotates in the normal direction) until the subtraction result achieves X pulses. As described above, the control unit 90 (the closer motor controller 95) performs the first returning operation and the second returning operation using the rotation amount of the closer motor 61 at the first rotational end in the close area as a reference.

Returning to FIGS. 3A to 4D, states of the sector gear 63, the latch 41, and the pole 42 during the close operation and the release operation are described. FIGS. 3A to 3D are diagrams schematically illustrating the states during the close operation and the neutrality returning operation thereafter (the first returning operation). FIGS. 4A to 4D are diagrams schematically illustrating the states during the release operation and the neutrality returning operation thereafter (the second returning operation).

The close operation is performed when the back door 3 opened from the vehicle body 1 is to be closed. When the back door 3 is in the opened state, due to the neutrality returning operation (the second returning operation) that follows the release operation performed in advance to open the back door 3, the rotational position of the sector gear 63 is the neutral position as illustrated in FIG. 3A. When the back 3 in the opened state is moved so as to be closed, the door opening and closing operation mechanism 40 provided on the side of the back door 3 approaches the striker fixed to the vehicle body 1.

The locking groove portion 413 of the latch 41 in the door opening and closing operation mechanism 40 receives the striker 2. When the back door 3 is further moved, as illustrated in FIG. 3B, the abutting operation portion 421 of the pole 42 is engaged with the first arm portion 411 of the latch 41 (the half latch position). When the latch 41 reaches the half latch position, the closer motor 61 is rotated in the normal direction (rotated counterclockwise), and the pinion gear 62 attached to the rotation shaft of the closer motor 61 is also rotated counterclockwise. When the pinion gear 62 is rotated counterclockwise, the sector gear 63 is rotated clockwise about the rotation shaft 63a. When the sector gear 63 is rotated, the linked close operation mechanism 51 is operated to rotate the latch 41 about the support shaft 41a. In addition, in this step, the back door 3 does not completely close the vehicle body 1.

When the sector gear 63 is further rotated to the first rotational end which is the final rotational end of the close area, as illustrated in FIG. 3C, the abutting operation portion 421 of the pole 42 is engaged with the second arm portion 421 of the latch 41 (the full latch position). In this step, the back door 3 completely closes the vehicle body 1.

When the close operation is ended, the closer motor 61 is rotated in the reverse direction to return the sector gear 63 to neutrality (rotated clockwise). The rotation counter 84 counts pulse signals that can be obtained in response to the rotation of the closer motor 61, and when the number of pulses set in advance is reached after the sector gear 63 starts rotating in the reverse direction from the first rotational end, the closer motor controller 95 stops the closer motor 61. In this case, the sector gear 63 is stopped at the neutral position as illustrated in FIG. 3D. As described above, the door opening and closing operation mechanism 40 performs the operation of closing the back door 3.

Here, the control may be described with reference to the timing diagram of FIG. 5. When the door motor is rotated in the normal direction by the control unit 90 and the latch 41 reaches the half latch position while the operation of closing the back door 3 is performed, the pole switch 83 is transited from the High (On) level to the Low (Off) level. At this timing, the control unit 90 stops the normal rotation of the door motor. In addition, the closer motor controller 95 rotates the closer motor 61 in the normal direction at the transited timing.

When the latch 41 reaches the full latch position, the pole switch 83 is transited from the High (On) level to the Low (Off) level. Then, the closer motor controller 95 recognizes that the sector gear 63 reaches the first rotational end at the transited timing and stops the normal rotation of the closer motor 61. Thereafter, the closer motor controller 95 rotates the closer motor 61 in the reverse direction to perform the first returning operation of the sector gear 63. With the start of the reverse rotation, the rotation counter 84 counts pulse signals. The closer motor controller 95 stops the reverse rotation of the closer motor 61 when the number of pulses reaches the number of pulses set in advance. According to the timing diagram, the door opening and closing operation mechanism 40 performs the operation of closing the back door 3.

The release operation is performed to open the back door 3 closing the vehicle body 1. When the back door 3 is in the opened state, due to the neutrality returning operation (the first returning operation) that follows the close operation performed in advance, the rotational position of the sector gear 63 is the neutral position as illustrated in FIG. 4A. When the closer motor 61 is rotated in the reverse direction by operating a handle switch (not shown) including the open handle 3a of the back door 3, as illustrated in FIG. 4B, the sector gear 63 is rotated toward the release area.

When the sector gear 63 is rotated, the linked release operation mechanism 52 is operated to rotate the pole 42 in a disengagement direction. As illustrated in FIG. 4C, when the abutting operation portion 421 of the pole 42 is disengaged from the latch 41, the pole 42 is returned to a home position (a posture of FIG. 3A or FIG. 4D) which is a disengagement posture by a spring biasing force. The latch 41 is returned to a posture to release the striker 2 by the spring biasing force. In this step, the back door 3 opens the vehicle body 1.

When the release operation is ended, the closer motor 61 is rotated in the normal direction to return the sector gear 63 to the neutrality. The rotation counter 84 counts pulse signals that can be obtained in response to the rotation of the closer motor 61. The closer motor controller 95 subtracts the number of pulses obtained after starting the normal rotation from the number of pulses acquired when the sector gear 63 is moved from the second rotational end and stops the closer motor 63 when the subtraction result reaches the number of pulses set in advance. In this case, the sector gear 63 is stopped at the neutral position as illustrated in FIG. 4D. In this manner, the door opening and closing operation mechanism 40 performs the operation of opening the back door 3.

The control (processes related to the second returning operation from the release operation) may be described with reference to the timing diagram of FIG. 5 along with the processes related to the first returning operation from the close operation. The handle switch is transited from the Low (Off) level to the High (On) level by operating the handle switch (not shown) including the open handle 3a of the back door 3. Then, the closer motor controller 95 rotates the closer motor 61 in the reverse direction at the transited timing.

When the latch 41 exceeds the full latch area, the second latch switch 82 is transited from the Low (Off) level to the High (On) level. Then, the closer motor controller 95 recognizes that the sector gear 63 reaches the second rotational end at the transited timing and stops the reverse rotation of the closer motor 61. In addition, the control unit 90 rotates the door motor in the reverse direction to open the back door 3. Thereafter, the closer motor controller 95 rotates the closer motor 61 in the normal direction to perform the second returning operation of the sector gear 63 at a time point at which the second latch switch 82 is transited from the High (On) level to the Low (Off) level. The closer motor controller 95 subtracts the number of pulses acquired after starting the normal rotation from the number of pulses counted at the second rotational end and stops the normal rotation of the closer motor 61 when the subtraction result reaches the number of pulses set in advance. In addition, the control unit 90 stops the reverse rotation of the door motor at a time point when the back door 3 is completely opened. According to the timing diagram described above, the door opening and closing operation mechanism 40 performs the operation of opening the back door 3.

Here, when the close operation of the back door 3 is ended, the opening and closing member control device 100 performs the first returning operation of the sector gear 63. During the first returning operation, the sector gear 63 is rotated in the reverse direction to pass the close area and then enter the neutral area, and is stopped at the neutral position. The detection of the neutral position is achieved on the basis of the pulse signals counted by the rotation counter 84.

However, in the case where the closer motor controller 95 controls the closer motor 61 to stop, and in the case where the closer motor 61 rotates at high speed, it is not easy to abruptly stop the closer motor 61 operated to displace the sector gear 63 due to the inertia of a rotor (not shown) of the closer motor 61. Accordingly, there is a possibility that the sector gear 63 may pass the neutral position and the neutral area and irrupt into the close area. In this case, the opening and closing member control device 100 may cause a malfunction during the operations of opening and closing the back door 3. In order to reliably prevent the malfunction, the opening and closing member control device 100 has a function of controlling a rotational speed of the closure motor 61.

In this embodiment, controlling the rotational speed of the closer motor 61 is achieved by controlling a supply voltage supplied to the closure motor 61. The voltage generator 60 generates the supply voltage using PWM (Pulse Width Modulation) control. Since the PWM control is a well-known technique, detailed description thereof will be omitted. The voltage generator 60 is configured as a step-down chopper circuit as illustrated in FIG. 11. The step-down chopper circuit mainly includes a MOS-FET (Metal Oxide Semiconductor-Field Effect Transistor) 60a, a diode 60b, a coil 60c, and a condenser 60d.

A voltage source 59 for outputting a predetermined voltage is connected to an input terminal (a source terminal of the MOS-FET 60a) of the step-down chopper circuit. As the power source 59, for example, a battery provided in the vehicle having the opening and closing member control device 100 may be employed. The closer motor 61 is connected to an output terminal of the step-down chopper circuit. Therefore, the chopper circuit steps down the predetermined output voltage of the voltage source 59 to a corresponding output voltage or less and supplies the stepped-down voltage as the supply voltage to the closer motor 61. The value of the supply voltage is determined by the control unit 90 based on the state of the latch 41. Accordingly, a gate terminal of the MOS-FET 60a is connected to the control unit 90. The closer motor controller 95 of the control unit 90 generates and outputs a PWM control signal related to the PWM control. The output voltage value is transmitted from the step-down chopper circuit to the control unit 90, and the control unit 90 performs feed-back control to maintain the output voltage value.

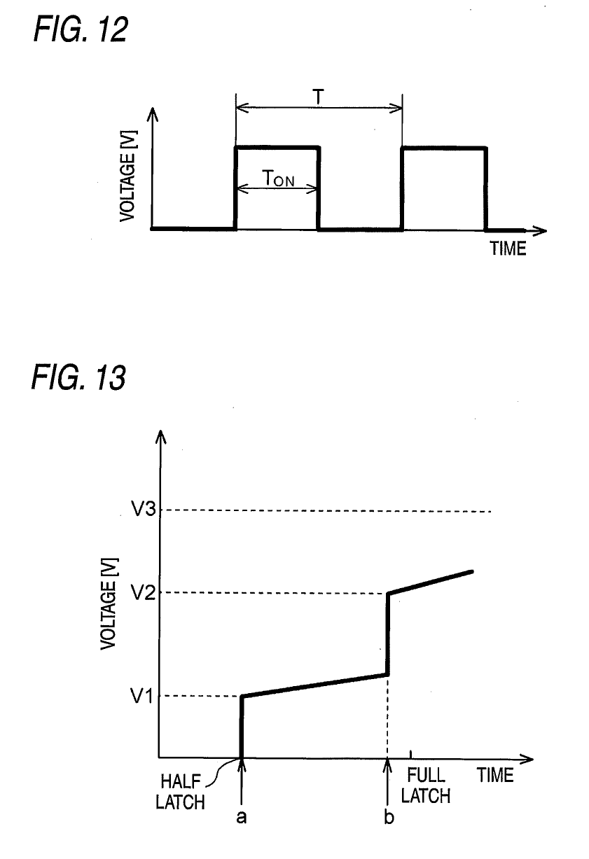

The maintaining of the output voltage, which is performed by the control unit 90, is carried out using the PWM control described above. That is, a PWM control signal as illustrated in FIG. 12 is output from the control unit 90. The PWM control signal is subjected to duty control to maintain the output voltage. The output voltage of the voltage generator 60 is determined as follows on the basis of the PWM control signal (however, in this case, loads and losses are ignored).

Expression 1

Vout=Ton/T×Vin (1)

where Vin is an input voltage, Vout is an output voltage, T is a time for one period, and Ton is a turn-on time corresponding to the one period.

When the voltage generator 60 controls a time T to be constant (that is, constant frequency control in a predetermined frequency band is performed), the control unit 90 controls an on-time to be increased when the output voltage is to be high and controls the on-time to be decreased when the output voltage is to be low. Here, the control unit 90 does not control the output voltage to always be constant and may suitably control the output voltage to be changed based on the situation.

For example, the control unit 90 may control the value of the supply voltage to be higher during the pulling of the striker 2 than during the release of the striker 2. In general, in terms of structure, an output (rotational torque) required for the closer motor 61 during the pulling of the striker 2 is higher than during the release of the striker 2 by the door opening and closing operation mechanism 40. For this, the control unit 90 sets the supply voltage to be higher during the pulling of the striker 2 than during the release of the striker 2 by the door opening and closing operation mechanism 40. Therefore, the door opening and closing operation mechanism 40 can pull in the striker 2 effectively.

FIG. 13 is a diagram illustrating an example of the supply voltage (the output voltage of the voltage generator 60) determined based on the state of the latch 41. In the diagram of FIG. 13, a horizontal axis represents the state of the latch 41 (particularly, represents a state after exceeding the half latch), and a vertical axis represents the supply voltage. As illustrated in FIG. 13, the output voltage at the time of reaching the half latch (for example, a time point of a) is set to V1, and is gradually increased from V1 to approach the full latch. Then, the output voltage at the time before reaching the full latch (for example, a time point of b) is set to V2. Thereafter, the output voltage is controlled to be gradually increased from V2. By performing the control, it is possible to smoothly engage the latch 41 and the striker 2 with each other although a load applied when the latch 41 and the striker 2 are engaged with each other is great.

In addition, the control unit 90 may determine the value of the supply voltage so as not to exceed an upper limit V3 (see FIG. 13) defined in advance. When the upper limit V3 is set to be at least equal to or less than a maximum absolute rated voltage of the closer motor 61, the closer motor 61 is controlled to be under the maximum absolute rated voltage and it is possible to prevent the closer motor 61 from being damaged.

In addition, the control unit 90 may determine the value of the supply voltage according to the load applied to the back door 3 during the close operation of the back door 3. In general, during the closing of the back door 3, there may be a case where a weather strip made of rubber or the like is provided between the vehicle body 1 and the back door 3 to prevent rain and water from entering the vehicle. Since the weather strip is made of rubber, a force in the opening direction occurs during the closing of the back door 3. Therefore, during the pulling of the striker 2, the striker 2 needs to be pulled in by a force greater than the above-mentioned force, and a large output (the rotational torque) is needed for the closer motor 61. Accordingly, the control unit 90 sets the supply voltage to be higher based on the load applied to the back door 3 during the closing of the back door 3.

In addition, the control unit 90 may control the value of the supply voltage to be gradually decreased when the closer motor 61 is to be stopped. When the closer motor 61 is to be stopped from the rotating state, due to the inertia of the rotating component such as the rotor of the closer motor 61, the closer motor 61 cannot abruptly stop even though it has to be stopped. That is, the rotating component such as the rotor is continuously rotated due to the inertia. Particularly, this significantly occurs when the rotational speed of the closer motor 61 is high. As described above, when the control unit 90 stops the closer motor 61, the supply voltage is controlled to be gradually decreased from the prior step (before a predetermined time) and is controlled to stop taking into account the rotation due to the inertia. As described above, the control unit 90 determines the supply voltage based on the state of the latch 41 and the back door 3.

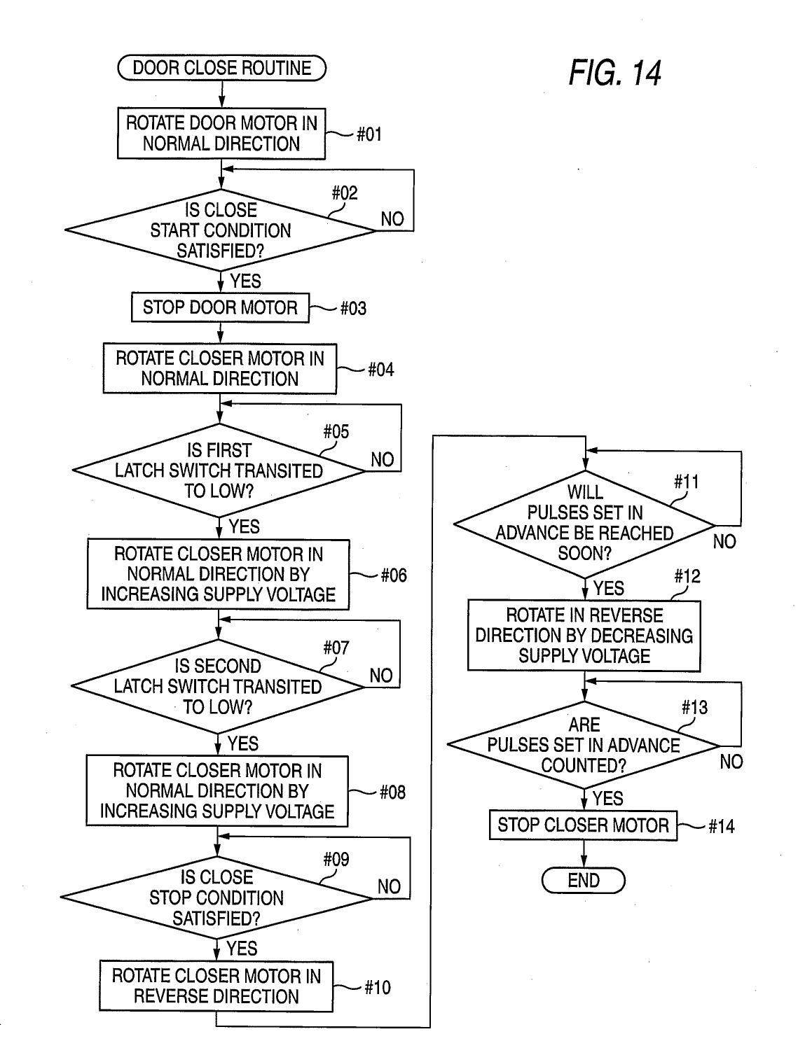

Next, processes performed by the opening and closing member control device 100 during the closing of the opened back door 3 will be described using the flowchart shown in FIG. 14. Here, the description will be provided with reference to the timing diagram of FIG. 5. First, the door motor (not shown) is rotated in the normal direction, and the back door 3 performs the close operation (Step #01).

When a close start condition of the door opening and closing operation mechanism 40 is satisfied (Yes in Step #02), the control unit 90 stops the door motor (Step #03) and rotates the closer motor 61 in the normal direction (Step #04). The close start condition is a condition for starting the close operation performed by the latch 41 to pull in the striker 2. In this embodiment, as illustrated in FIG. 5, when the first latch switch 81 is in the High (On) level, the transition of the pole switch 83 from the High (On) level to the Low (Off) level is defined as the close start condition. When the close start condition is not satisfied (No in Step #02), the control unit 90 continuously rotates the door motor in the normal direction.

When the first latch switch 81 is transited from the High (On) level to the Low (Off) level after starting the normal rotation of the closer motor 61 (Yes in Step #05), that is, when the half latch is exceeded, the control unit 90 sets the supply voltage of the closer motor 61 to be higher (for example, to V1) and gradually increases the voltage value to continue the normal rotation (Step S06). When the first latch switch 81 is not transited to the Low (Off) level from the High (On) level (No in Step #05), the control unit 90 does not change the supply voltage and continues the normal rotation of the closer motor 61.

In the case where the supply voltage of the closer motor 61 is set to be high (for example, to V1) and performs the normal rotation, when the second latch switch 82 is transited from High (On) level to the Low (Off) level (Yes in Step #07), the control unit 90 sets the supply voltage of the closer motor 61 to be higher (for example, to V2) and continues the normal rotation while gradually increasing the voltage value (Step #08). When the second latch switch 82 is not transited from the High (On) level to the Low (Off) level (No in Step #07), the control unit 90 does not further increase the supply voltage (does not change the supply voltage to V2) and continues the normal rotation of the closer motor 61.

Here, when a close stop condition of the door opening and closing operation mechanism 40 is satisfied (Yes in Step #09), the control unit 90 rotates the closer motor 61 in the reverse direction (Step #10). The close stop condition is a condition for stopping the pulling of the striker 2 performed by the latch 41. In this embodiment, as illustrated in FIG. 5, when the first latch switch 81, the second latch switch 82, and the pole switch 83 are respectively in the Low (Off) level, in the Low (Off) level, and transited from the High (On) level to the Low (Off) level, the close operation is stopped. When the close stop condition is not satisfied (No Step #09), the control unit 90 continuously rotates the closer motor 61 in the normal direction.

When the close stop condition is satisfied, the control unit 90 rotates the closer motor 61 in the reverse direction to perform the first returning operation of the sector gear 63 (Step #10). In addition, the rotation counter 84 counts the output pulses acquired after the reverse rotation of the closer motor 61. When the number of the output pulses approaches the number of pulses set in advance (Yes in Step #11), the control unit 90 sets the supply voltage to be low (Step #12). On the other hand, when the number of output pulses counted after the reverse rotation of the closer motor 61 becomes further from the number of pulses set in advance (No in Step #11), the control unit 90 does not set the supply voltage to be low and continues the reverse rotation of the closer motor 61.

When the number of output pulses counted by the rotation counter 84 after the reverse rotation of the closer motor 61 reaches the number of pulses set in advance (Yes in Step #13), the control unit 90 stops the closer motor 61 (Step #14). On the other hand, when the number of the output pulses does not reach the number of pulses set in advance (No in Step #13), the reverse rotation of the closer motor 61 is continued. Here, the number of pulses set in advance is output pulses output according to the rotational power of the closer motor 63 which is needed for the sector gear 63 positioned at the first rotational end to reach the neutral position. The opening and closing member control device 100 can suitably stop the sector gear 63 at the neutral position after performing the first returning operation by performing the control as described above when the back door 3 is to be closed.

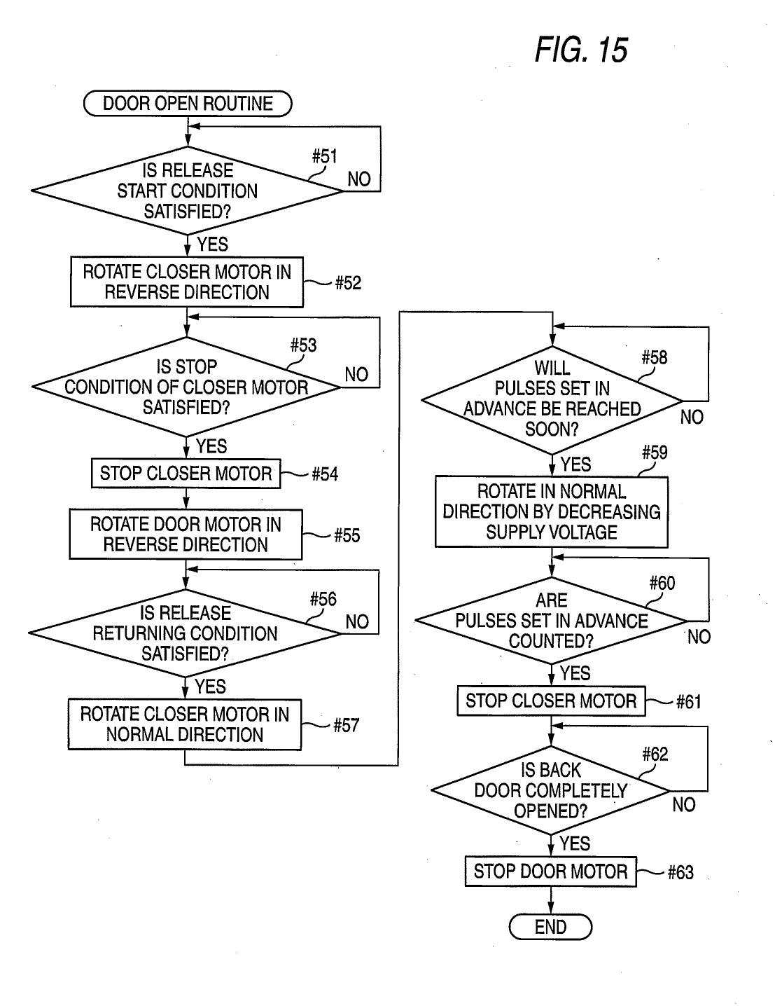

Next, processes performed by the opening and closing member control device 100 during the opening of the closed back door 3 will be described using the flowchart shown in FIG. 15. Here, the description will be provided with reference to the timing diagram of FIG. 5. When the release start condition of the door opening and closing operation mechanism 40 is satisfied (Yes in Step #51), the control unit 90 allows the closer motor 61 to rotate in the reverse direction (Step #52). The release start condition is a condition for starting the release operation to release the striker 2. In this embodiment, as illustrated in FIG. 5, the transition of the handle switch (not shown) from the Low (Off) level to the High (On) level when the first latch switch 81 and the second latch switch 82 are in the Low (Off) levels is the condition. When the release start condition is not satisfied (No in Step #51), the control unit 90 is in a standby state to satisfy the release start condition (detection standby).

When the stop condition of the closer motor 61 is satisfied (Yes in Step #53) after starting the reverse rotation of the closer motor 61, the closer motor 61 is stopped (Step #54). The stop condition of the closer motor 61 is, in this embodiment, the transition of the second latch switch 82 from the Low (Off) level to the High (On) level when the first latch switch 81 is in the Low (Off) level as illustrated in FIG. 5. When the stop condition of the closer motor 61 is not satisfied (No in Step #53), the control unit 90 continuously rotates the closer motor 61 in the reverse direction.

When the closer motor 61 is stopped as described above (Step #54), the control unit 90 rotates the door motor in the reverse direction (Step #55). When a release returning condition of the door opening and closing operation mechanism 40 is satisfied (Yes in Step #56), the control unit 90 rotates the closer motor 61 in the normal direction (Step #57). The release returning condition is a condition for starting the second returning operation after the release operation performed by the sector gear 63. In this embodiment, as illustrated in FIG. 5, the condition is the transition of the second latch switch 82 from the High (On) level to the Low (Off) level when the first latch switch 81 is in the High (On) level. When the release returning condition is not satisfied (No in Step #56), the control unit 90 is in a standby state to satisfy the release returning condition (detection standby).

When the release returning condition is satisfied, the control unit 90 rotates the closer motor 61 in the normal direction to perform the second returning operation of the sector gear 63 (Step #57). In addition, the rotation counter 84 counts the output pulses acquired in response to the rotation of the closer motor 61. When the number of output pulses approaches the number of pulses set in advance (Yes in Step #58), the control unit 90 sets the supply voltage to be low (Step #59). On the other hand, when the number of pulses becomes further from the number of pulses set in advance (No in Step #58), the control unit 90 continuously rotates the closer motor 61 in the normal direction without setting the supply voltage to be low.

When the number of output pulses reaches the number of pulses set in advance (Yes in Step #60), the control unit 90 stops the closer motor 61 (Step #61). On the other hand, when the number of pulses does not reach the number of pulses set in advance (No in Step #60), the normal rotation of the closer motor 61 is continued. Here, the number of pulses set in advance is output pulses output according to the rotational power of the closer motor 63 corresponding to the neutral position defined with respect to the first rotational end.

In addition, the control unit 90 continuously performs the control for opening the back door 3 when the sector gear 63 performs the second returning operation. The control for opening the door is continuously performed until the back door 3 is completely opened (No in Step #62). When the back door 3 is completely opened (Yes in Step #62), the control unit 90 stops the door motor (Step #63) and ends the processes. The opening and closing member control device 100 can suitably stop the sector gear 63 at the neutral position after performing the second returning operation by performing the control as described above when the back door 3 is to be opened.

Therefore, according to this embodiment, since the rotation of the closer motor 61 is controlled on the basis of the rotation amount of the closer motor 61, a switch for recognizing the neutral position is not needed, and it is possible to set a neutral position without a dispersion. That is, when a switch for recognizing the neutral position is set, dispersion on installing the switch and dispersion of inherent detection characteristics of the switch need to be considered. However, when the switch is not needed, there is no need to consider the dispersions. In other words, in this embodiment, the number of processes to install the switch at a suitable position with high precision can be reduced, and setting the neutral area in consideration of the dispersion is not necessary.

In addition, since it is possible to set a narrow neutral area, it is possible to reduce an operational range (operation stroke) of the displacement member (the sector gear 63). Accordingly, a decrease in size of the displacement member and a decrease in size of the opening and closing member control device 100 can be achieved, and a mounting space in the back door 3 can be reduced. Therefore, the mounting space of the opening and closing member control device 100 is not easily limited by the size and shape of the opening and closing member such as the back door 3, and it is possible to enhance the degree of freedom for mounting the opening and closing member control device 100 in the vehicle.

Moreover, by controlling power supply (the supply voltage) to the closer motor 61, the supply voltage can be set to be low, for example, during the close operation since there is no need to supply unnecessarily high pulling power in the area where loads such as reaction force from the weather strip are not added, and the supply voltage can be set to be high in the area where the loads such as the reaction force from the weather strip are added. For this, even in the case where loads added to the back door 3 are different depending on the vehicle, the value of the supply voltage can be set according to the loads and it is possible to smoothly complete the close operation.

Moreover, when the closer motor 61 is stopped, the supply voltage is gradually decreased. Therefore, an amount of movement of the sector gear 63 due to the inertia can be reduced and it is possible to suitably stop the sector gear 63 at a desired position.

### Other Embodiments

In the description of the above-mentioned embodiment, the rotation counter 84 counts the pulse signals output in response to the rotation of the permanent magnet provided in the vicinity of the rotation shaft of the closer motor 61. However, the scope of the invention is not limited thereto. For example, the rotation amount of the closer motor 61 may be counted by counting ripple pulses on the basis of ripples of motor current flowing through the closer motor 61.

In the description of the above-mentioned embodiment, the number of pulses at the neutral position used to perform the first and second returning operations is set in advance with respect to the first rotational end. However, the scope of the invention is not limited thereto. The number of pulses at the neutral position may be set with respect to the second rotational end, and the number of pulses may be set with respect to the neutral position. In addition, the first and second rotational ends themselves may be set to references (origins). For example, for the first returning operation, the number of pulses at the neutral position with respect to the first rotational end may be set, and for the second returning operation, the number of pulses at the neutral position with respect to the second rotational end may be set.

In the description of the above-mentioned embodiment, the door motor is stopped when the back door 3 is completely opened during the opening. However, the scope of the invention is not limited thereto. Stopping the back door 3 when the back door 3 is opened at an arbitrary degree can be implemented.

In the description of the above-mentioned embodiment, the voltage generator 60 generates the supply voltage supplied to the closer motor 61 using PWM control. However, the scope of the invention is not limited thereto. The configuration may use PFM (Pulse Frequency Modulation) control. Otherwise, a plurality of regulators are used to supply outputs of the regulators to the closer motor 61 while varying the outputs based on the state of the latch 41.

In the description of the above-mentioned embodiment, the opening and closing member corresponds to the back door 3 of the vehicle, and the opening and closing member control device 100 is applied as a door closer control device of the back door 3. However, the scope of the invention is not limited thereto. For example, a slide door of the vehicle may be used as the opening and closing member. In this case, by applying the invention to the opening and closing member control device for opening and closing the slide door, the same effects can be obtained. In addition, for example, the invention may also be applied to a closer device of a swing door, a luggage closer device, or the like. Furthermore, the invention needs not be necessarily applied to the opening and closing member for a vehicle and for example, may be applied to an opening and closing member control device for a house.

In the description of the above-mentioned embodiment, a case where a power transmission mechanism using the sector gear 63 as the displacement member is exemplified. However, the scope of the invention is not limited thereto. For example, a power transmission mechanism using a planetary gear may be employed. In this case, the displacement member may be a component (linear gear) of the power transmission mechanism using the planetary gear.

The invention may be used for an opening and closing member control device which performs a close operation for establishing an engagement state of a latch and a striker, and a release operation for releasing the engagement state of the latch and the striker according to a rotational displacement due to an operation of a motor.

What is claimed is:

1. An opening and closing member control device comprising:
a latch that pulls in or releases a striker;
a displacement member that operates the latch through a latch operation mechanism and is displaced within a movement area including a close area for allowing the latch to be in a pulling state, a release area for allowing the latch to be in a releasing state, and a neutral area positioned between the close and release areas;
a motor that displaces the displacement member;
a rotation counter that counts a rotation amount of the motor; and
a control unit that controls, based on the rotation amount of the motor, rotation of the motor to perform a first returning operation for returning the displacement member to a neutral position set in the neutral area from the close area after a close operation of the displacement member, and a second returning operation for returning the displacement member to the neutral position from the release area after a release operation of the displacement member.

2. The opening and closing member control device according to claim 1, wherein the control unit performs the first and second returning operations based on the rotation amount of the motor at a rotational end of the close area.

3. The opening and closing member control device according to claim 1, further comprising:
a latch state evaluator that evaluates a state of the latch; and
a voltage generator that generates a supply voltage supplied to the motor using PWM control,
wherein the control unit determines a value of the supply voltage based on the state of the latch.

4. The opening and closing member control device according to claim 3, wherein the control unit controls the value of the supply voltage so as not to exceed an upper limit defined in advance.

5. The opening and closing member control device according to claim 3 or 4, wherein the control unit determines the value of the supply voltage to be higher during pulling of the striker than during release of the striker.

6. The opening and closing member control device according to claim 3, wherein, during the close operation of an opening and closing member, the control unit determines the value of the supply value based on a load applied to the opening and closing member.

7. The opening and closing member control device according to claim 3, wherein the control unit controls the value of the supply voltage to be gradually decreased when the motor is to be stopped.

8. A opening and closing member control device comprising:
a latch that pulls in or releases a striker;
a displacement member that operates the latch through a latch operation mechanism and is displaced within a movement area including a close area for allowing the latch to be in a pulling state, a release area for allowing the latch to be in a releasing state, and a neutral area positioned between the close and release areas;
a latch state evaluator that evaluates a state of the latch;
a motor that displaces the displacement member;
a control unit that determines a value of a supply voltage supplied to the motor based on the state of the latch; and
a voltage generator that generates the supply voltage at the determined value using PWM control.

9. The opening and closing member control device according to claim 8, wherein the control unit controls the value of the supply voltage so as not to exceed an upper limit defined in advance.

10. The opening and closing member control device according to claim 8, wherein the control unit determines the value of the supply voltage to be higher during pulling of the striker than during release of the striker.

11. The opening and closing member control device according to claim 8, wherein, during the close operation of an opening and closing member, the control unit determines the value of the supply value based on a load applied to the opening and closing member.

12. The opening and closing member control device according to claim 8, wherein the control unit controls the value of the supply voltage to be gradually decreased when the motor is to be stopped.
